(19) United States
(12) Patent Application Publication
(10) Pub. No.: US 2013/0205196 A1
(43) Pub. Date: Aug. 8, 2013

(54) LOCATION-BASED MOBILE APPLICATION MARKETPLACE SYSTEM

(71) Applicants: Dongsoo Han, Daejeon (KR); Minkyu Lee, Daejeon (KR); Woohyuk Jang, Bucheon-si (KR)

(72) Inventors: Dongsoo Han, Daejeon (KR); Minkyu Lee, Daejeon (KR); Woohyuk Jang, Bucheon-si (KR)

(73) Assignees: VISOFT LTD., Daejeon (KR); KOREA ADVANCED INSTITUTE OF SCIECNE AND TECHNOLOGY, Daejeon (KR)

(21) Appl. No.: 13/878,624

(22) PCT Filed: Jan. 17, 2011
(86) PCT No.: PCT/KR2011/000331

§ 371 Date: Apr. 10, 2013

(30) Foreign Application Priority Data
Oct. 11, 2010 (KR) 10-2010-0098707

(51) Int. Cl. G06F 17/22

(52) U.S. Cl. CPC G06F 17/2247
USPC 715/234

(57) ABSTRACT

A marketplace system includes a mobile application registration unit configured to allow a user to register a mobile application which is to be provided for a mobile terminal; a linked site-mobile application database configured to store information on a link between a mobile application and a site which a mobile application is to be provided for; and a mobile application list unit configured to receive location information from a mobile terminal which wishes to receive a mobile application, determine a site including a location of the mobile terminal, which wishes to receive the mobile application, based on the received location information, generate a list of mobile applications linked to the determined site using the linked site-mobile application database and provide the list of mobile applications for the mobile terminal which wishes to receive the mobile application.

### TECHNICAL FIELD

The present invention relates to a marketplace system and method for providing a mobile application which corresponds to a location of a mobile terminal when a request for the mobile application is received from the mobile terminal.

### BACKGROUND ART

Recently, as mobile terminals, such as smart phones, have become very popular, a variety of mobile applications have been actively developed. Along with such an active development of mobile applications, a mobile terminal user accesses a mobile application marketplace, such as an App store, and downloads a mobile application of interest. For this purpose, the mobile terminal user attempts to search a predefined top-down directory structure for the mobile application, or enter a specific keyword to retrieve the mobile application.

In order to support such a search for the mobile application, the mobile application has to be mapped to one or more keywords related to the mobile application when the mobile application is registered. Alternatively, the mobile application has to be registered with a category which is related to the mobile application from among a variety of predefined categories.

A mobile application marketplace system is a system which generally includes a server for processing the registration, search and distribution of mobile applications, programs which are installed in the server, and a service system, such as accounting.

As mobile applications for mobile terminals have become popular and distribution systems of the mobile applications through the mobile application marketplace has become convenient, individuals, public institutions, business entities, or small stores have also attempted to develop and distribute mobile applications specialized for their own businesses.

The mobile applications which are distributed by the public institutions, the business entities, or the small stores may be classified into mobile applications relevant to their locations and mobile applications irrelevant to their locations.

In the case of a mobile application related to a bank, a mobile application for checking a bank statement is a mobile application irrelevant to location, while a mobile application for distributing waiting number tickets for consultation is a mobile application relevant to location since it is only available for a bank relevant to the mobile application.

The mobility and instantaneity of mobile terminals have prompted an increased use of mobile applications. Accordingly, the public institutions, the business entities, or the small stores are expected to make a more active effort to develop and distribute mobile applications relevant to their own locations.

On the other hand, in the case of the existing search method of mobile applications, it is obvious that a continuously increased number of mobile applications may cause the mobile terminal user to experience increased difficulty in searching for his or her desired mobile application from among a great number of mobile applications.

For example, in order to search for a mobile application for information on a museum or an exhibition hosted by the museum, a user visiting the museum has to access a mobile application marketplace system and search a category which is expected to include the mobile application or enter a keyword which is expected to be mapped to the mobile application in a search window to search for the mobile application.

In this case, the user has to make a search for a pertinent category or find an exact keyword in order to make a quick search for his or her desired mobile application. Such a search for a pertinent category or such a finding of an exact keyword may lay a burden on a user who is unfamiliar with search for mobile applications.

Even a user who is familiar with search for a category or finding of a keyword may not use a mobile application of interest since there is no way to check if the mobile application of interest is available at his or her location.

Besides, such a keyword search for the name of a location, building or store may result in downloading a wrong mobile application for a different location, building or store with a similar name. Accordingly, it is highly probable that an increased number of registered mobile applications will cause such a confusion to become more serious.

### DISCLOSURE OF INVENTION

### Technical Problem

In view of the foregoing, the present invention provides a mobile application marketplace system which allows a user to easily obtain a mobile application related to the user's location.

Further, the present invention provides a mobile application marketplace system which allows a user to easily search for a mobile application related to the user's location.

In addition, the present invention provides a method for providing a mobile application, which allows a user to easily obtain the mobile application related to the user's location.

Further, the present invention provides a method for providing a mobile application, which allows a user to easily search for the mobile application related to the user's location.

### Technical Solution

In accordance with one aspect of the present invention, there is provided a marketplace system providing a mobile application for a mobile terminal, including a mobile application registration unit configured to allow a user to register a mobile application which is to be provided for a mobile terminal; a linked site-mobile application database configured to store information on a link between a mobile application and a site which a mobile application is to be provided for; and a mobile application list unit configured to receive location information from a mobile terminal which wishes to receive a mobile application, determine a site including a location of the mobile terminal, which wishes to receive the mobile application, based on the received location information, generate a list of mobile applications linked to the determined site using the linked site-mobile application database, and provide the list of mobile applications for the mobile terminal which wishes to receive the mobile application.

In accordance with another aspect of the present invention, there is provided a marketplace system providing a mobile application for a mobile terminal, including a mobile application registration unit configured to allow a user to register a mobile application which is to be provided for a mobile terminal; a linked site-mobile application database configured to store information on a link between a mobile application and a site which a mobile application is to be provided for; and a mobile application list unit configured to receive a WiFi fingerprint as location estimation information used to estimate a location of a mobile terminal from the mobile terminal which wishes to receive a mobile application, determine a site including an estimated location from the received WiFi fingerprint, generate a list of mobile applications linked to the determined site using the linked site-mobile application database, and provide the list of mobile applications for the mobile terminal which wishes to receive the mobile application, wherein the WiFi fingerprint is a set of identification information of an access point (AP), which outputs a WiFi signal received by the mobile terminal which wishes to receive the mobile application, and a WiFi signal strength.

In accordance with a further aspect of the present invention, there is provided a marketplace system providing a mobile application for a mobile terminal, including a mobile application registration unit 211 configured to receive (i) a mobile application which is to be provided for a mobile terminal at a particular location and (ii) a WiFi fingerprint collected at the particular location, the WiFi fingerprint being a set of identification information of an access point (AP) outputting a WiFi signal and a WiFi signal strength, and store information on a link between the received mobile application and the WiFi fingerprint in a mobile application management search database (220); and a mobile application list unit (212) configured to receive a WiFi fingerprint from a mobile terminal which wishes to receive a mobile application, compare the received WiFi fingerprint with each of WiFi fingerprints stored in the mobile application management search database (220) to extract a WiFi fingerprint with a similarity of a predetermined level or more from among the WiFi fingerprints stored in the mobile application management search database (220), generate a list of mobile applications which are linked to the extracted WiFi fingerprint, and provide the list of mobile applications for the mobile terminal which wishes to receive the mobile application.

### Advantageous Effects

According to an aspect of the present invention, a list of mobile applications available at a location where a mobile terminal is located is automatically provided. Accordingly, the mobile application search according to an embodiment of the present invention allows easier selection and use of a mobile application of interest than the existing mobile application search using a directory search or a keyword search.

According to an aspect of the present invention, a user may easily select a mobile application of interest from among a list of mobile applications which is automatically provided, without being concerned about which mobile application is proper at the user's location.

### DESCRIPTION OF DRAWINGS

FIG. 1 illustrates a mobile application marketplace system 200 and in what manner a mobile application is registered according to an embodiment of the present invention;

FIG. 2 illustrates a mobile application marketplace system 200 and in what manner a mobile application is searched according to an embodiment of the present invention;

FIG. 3 illustrates a site ontology according to an embodiment of the present invention;

FIG. 4 illustrates a structure of a mobile application marketplace system 200 according to an embodiment of the present invention;

FIG. 5 illustrates a method for searching and providing a mobile application based on location information received from a mobile terminal;

FIG. 6 illustrates a method for searching and providing a mobile application based on location estimation information received from a mobile terminal;

FIG. 7 illustrates a search method using a space index array according to an embodiment of the present invention;

FIG. 8 illustrates a structure of a mobile application marketplace system without location estimation according to an embodiment of the present invention;

FIG. 9 illustrates a method for searching and providing a mobile application by a mobile application marketplace system according to an embodiment of the present invention; and

FIG. 10 illustrates a WiFi fingerprint and a WiFi radio map.

### MODE FOR INVENTION

The following detailed description is provided to assist one skilled in the art in gaining a comprehensive understanding of exemplary embodiments of the present invention described herein with reference to the accompanying drawings. However, the present invention is not limited to the embodiments disclosed below but can be implemented in various forms. Description of functions and structures unrelated to the embodiments of the invention is omitted from the drawings in order to enhance clarity and conciseness. Further, like elements are denoted by like reference numerals throughout the drawings and the detailed description.

Throughout this specification, when an element “comprises,” “includes,” or “has” an element, it does not preclude another component but may further include the other element unless the context clearly indicates otherwise. As used herein, the term “. . . unit,” “. . . device,” “. . . module,” or the like denotes an element of processing at least one function or operation, and may be implemented as hardware, software, or combination of hardware and software.

### 1. Application of Mobile Application Marketplace System 200

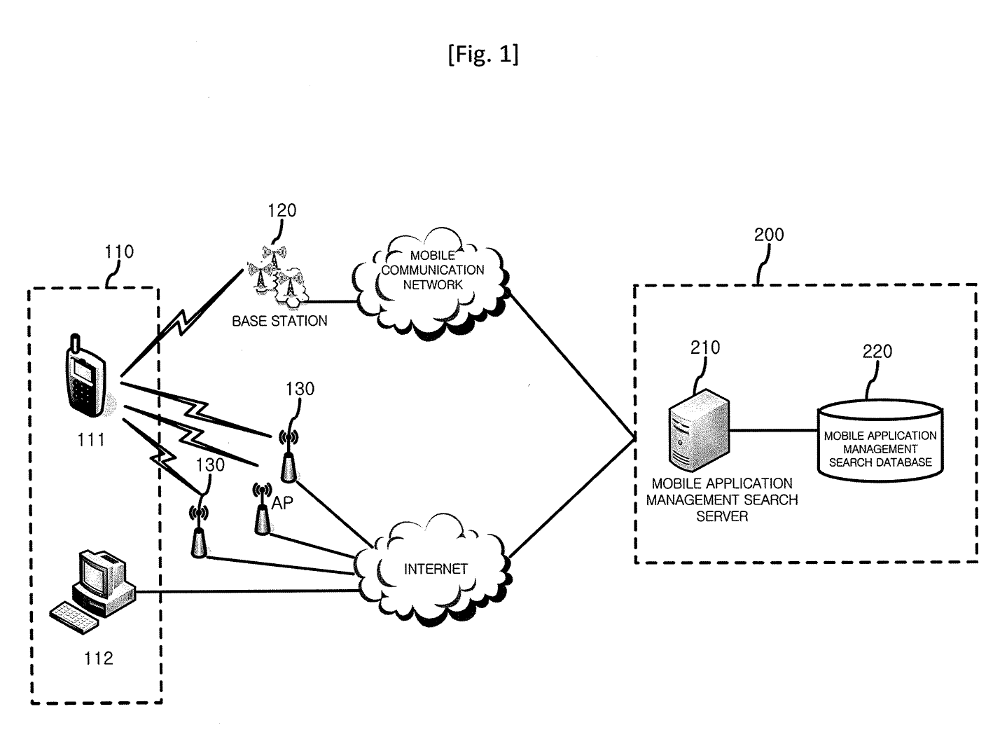

FIG. 1 illustrates a mobile application marketplace system 200 and in what manner a mobile application is registered according to an embodiment of the present invention.

The mobile application marketplace system 200 includes a mobile application management search server 210 and a mobile application management search database 220.

A person who wishes to register a mobile application may use his or her own terminal 110 to register the mobile application. Specifically, the registering person may use a mobile terminal 111 or a stationary terminal 112 to register the mobile application.

The registering person registers the mobile application in association with the mobile application management search server 210, and specifies a site which the mobile application is to be provided for. Information on the mobile application and the site is stored in the mobile application management search database 220. Alternatively, the registering person may register the mobile application, receive a WiFi fingerprint collected at a location where the mobile application is to be provided, and store information on a link between the mobile application and the WiFi fingerprint in the mobile application management search database 220. The WiFi fingerprint will be described in detail.

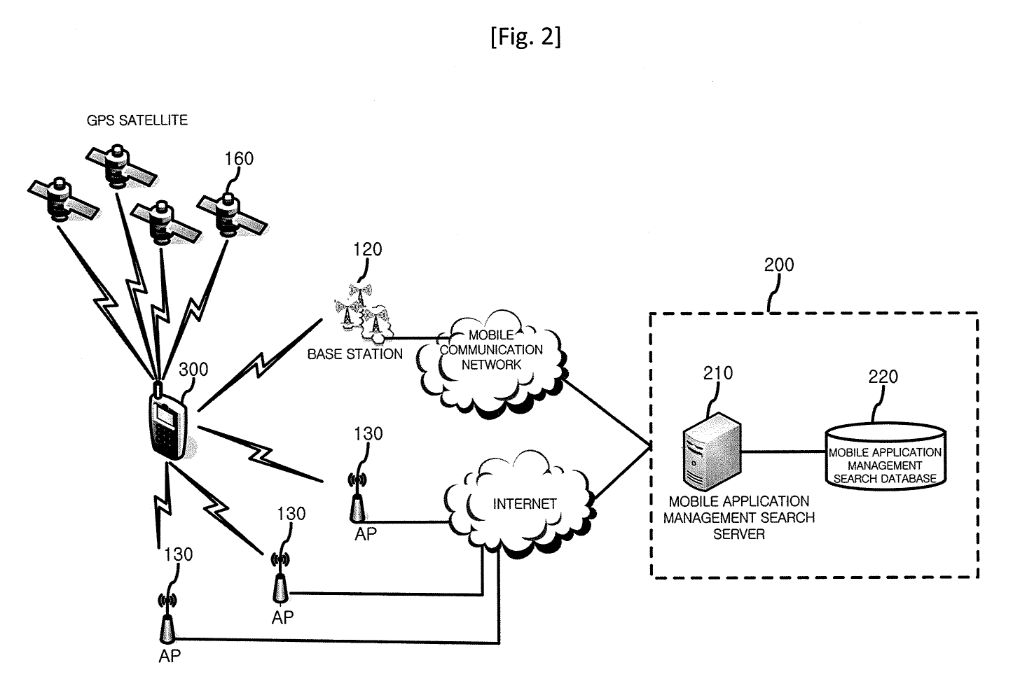

FIG. 2 illustrates a mobile application marketplace system 200 and in what manner a mobile application is searched according to an embodiment of the present invention.

Unlike the mobile terminal 111 in FIG. 1, a mobile terminal 300 is a terminal which wishes to receive a mobile application.

The mobile terminal 300 includes a built-in application program configured to download a location-based mobile application, transmits information on its own location, location estimation information which is used to generate location information, or a WiFi fingerprint to the mobile application marketplace system 200, receives a list of mobile applications available at its own location from the mobile application marketplace system 200, selects a mobile application of interest from among the list of mobile applications, and downloads the selected mobile application.

The mobile application marketplace system 200 extracts a list of mobile applications linked to a site including the location or estimated location of the mobile terminal 300 based on the location information, the information used to generate the location information, or the WiFi fingerprint which is received from the mobile terminal 300. Alternatively, the mobile application marketplace system 200 extracts a list of mobile applications based on the WiFi fingerprint collected by the mobile terminal 300. The mobile application marketplace system 200 then provides the list of mobile applications for the mobile terminal 300.

Upon receipt of a request for providing the selected mobile application from the mobile terminal 300, the mobile application marketplace system 200 provides the mobile application for the mobile terminal 300.

In exemplary embodiments of the present invention, the registration and search of mobile applications with location estimation and without location estimation will be described.

In the registration and search of mobile applications with location estimation, a location of a mobile terminal is estimated and a mobile application available at the location is recommended. In the registration and search of mobile applications without location estimation, a mobile application corresponding to a location of a mobile terminal is recommended without the need to estimate the location of the mobile terminal.

### 2. Registration and Search of Mobile Applications with Location Estimation

In an embodiment, the term “site” refers to a basic unit of geographical area which a mobile application is provided for. The mobile application may be provided for a single site or a plurality of sites. The same mobile application may be provided for a plurality of sites which are adjacent to each other or spaced apart from each other. Like an area of a particular lot number which is displayed on a land register map, a range of a geographical area of each site may be definitely defined and displayed in exact numerical values. It should be understood that a large building may have a different site for each floor or each room.

### Structure of Mobile Application Marketplace System

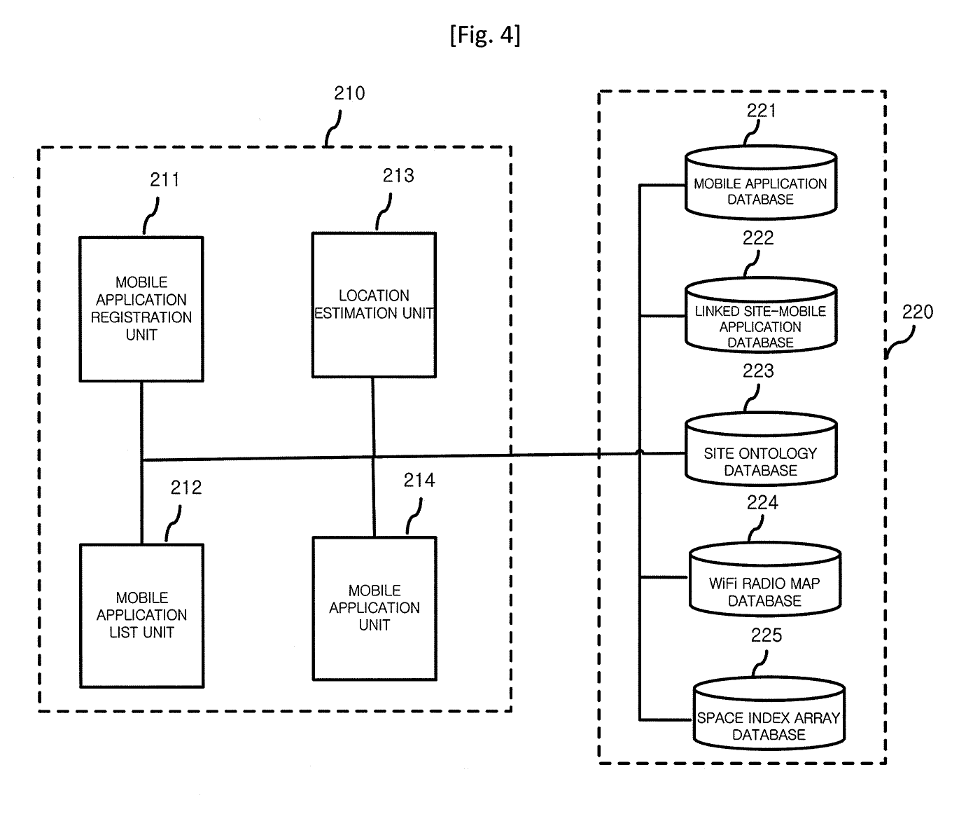

FIG. 4 illustrates a structure of a mobile application marketplace system 200 according to an embodiment of the present invention.

The mobile application marketplace system 200 includes a mobile application management search server 210 and a mobile application management search database 220.

The mobile application management search server 210 includes a mobile application registration unit 211, a mobile application list unit 212, a location estimation unit 213, and a mobile application unit 214.

The mobile application management search database 220 includes a mobile application database 221, a linked site-mobile application database 222, a site ontology database 223, a WiFi radio map database 224, and a space index array database 225.

The mobile application registration unit 211 is configured to register a mobile application to be provided for a mobile terminal.

The mobile application list unit 212 is configured to receive location information of a mobile terminal or location estimation information used to generate location information of the mobile terminal and determine a site including the location of the mobile terminal. The mobile application list unit 212 further generates a list of mobile applications linked to the determined site using the linked site-mobile application database 222, and provides the list of the mobile applications for the mobile terminal.

The location estimation unit 213 is configured to estimate a location of a mobile terminal using the location estimation information. For example, if a WiFi fingerprint is received as location estimation information, the location of the mobile terminal 300 is estimated using the received WiFi fingerprint based on the WiFi radio map database 224. The location estimation using the WiFi fingerprint and the WiFi radio map database will be described.

The mobile application unit 214 is configured to provide a mobile application for the user's mobile terminal 300 when the user selects a mobile application of interest from among the list of mobile applications.

The mobile application database 221 is a database for storing mobile applications which are registered by the registering person. The linked site-mobile application database 222 is a database for storing information on a link between a mobile application and a site which the mobile application is to be provided for.

The site ontology database 223 includes a physical site directory and a logical site directory. The site ontology database 223 includes predefined symbolic tags which are classification items of each of the physical site directory and the logical site directory.

The WiFi radio map database 224 is a database for storing a WiFi radio map. For a space divided into grid areas, the space index array database 225 is a database for storing information on a coordinate range of each of the grid areas and information on sites which overlap with each of the grid areas.

Functions of the above-mentioned elements of the mobile application management search server 210 and the mobile application management search database 220 will become more apparent from the following description of the registration and search of the mobile application.

### Registration of Mobile Application Based on Coordinates

A method for specifying a range for providing a mobile application and registering the mobile application based on coordinates according to an embodiment of the present invention will be described.

The mobile application registration unit 211 receives a mobile application from the terminal 110 of the registering person and stores the mobile application in the mobile application database 221. In this case, the mobile application registration unit 211 stores information on a link between the mobile application and the site which the mobile application is to be provided for.

In an embodiment of the present invention, a method for specifying a site where a mobile application is to be provided based on coordinates is performed taking into account the following: (i) using a map, and (ii) using GPS coordinate information and/or a WiFi fingerprint.

In the case of using a map, the mobile application registration unit 211 provides a map for the terminal 110 of the registering person, and the registering person selects the central point and radius of a site where the mobile application is to be provided on the map. Alternatively, the registering person may directly mark a closed curve on the map.

In the case of using GPS coordinate information and/or a WiFi fingerprint, the mobile application registration unit 212 receives from the registering person's mobile terminal 111 information on a location and a radius which are calculated from a GPS satellite signal measured at a site where the registering person is to provide a mobile application, or receives from the registering person's mobile terminal 111 a WiFi fingerprint and a radius which are collected by the mobile terminal 111. If the WiFi fingerprint is received, the location estimation unit 213 estimates the location of the mobile terminal 111 using the WiFi radio map 224 and the received WiFi fingerprint. The site which the mobile application is to be provided for is defined as an area which is formed by the radius determined by the registering person with respect to a central point which is the location based on the received GPS location information or the location estimated using the WiFi fingerprint.

A method for estimating the location of the mobile terminal 111 using the WiFi fingerprint will be described.

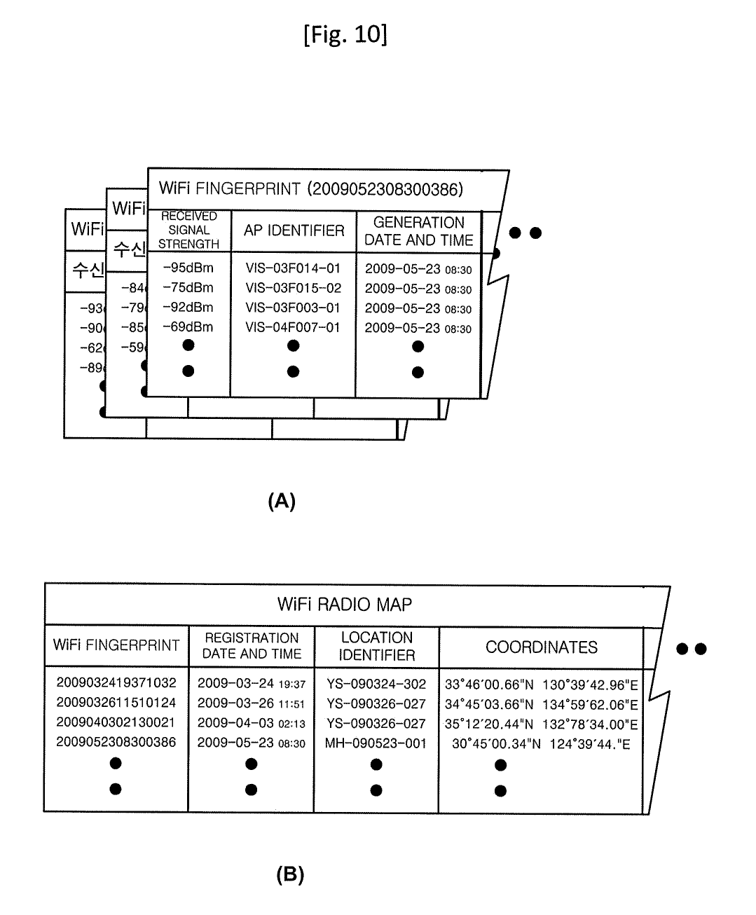

FIG. 10 illustrates a WiFi fingerprint and a WiFi radio map.

The WiFi fingerprint is a set of identification information of an AP outputting a WiFi signal and a WiFi signal strength. Depending on a collecting point of the signal, APs neighboring to the collecting point may be different and signal strengths also may be different. The WiFi radio map is a set of a WiFi fingerprint and location information of a collecting point of the WiFi fingerprint.

If a WiFi fingerprint measured and collected from the mobile terminal 111 at a certain location is given, the location of the mobile terminal 111 may be mathematically estimated from a database of the WiFi fingerprints and the WiFi radio map as shown in FIG. 10.

In the case of a mathematical method, each WiFi fingerprint is considered a vector with a factor of signal strength from an AP. Assuming that there are m APs in the database, each WiFi fingerprint may be mapped to an m-order vector area. If a Euclidean distance between a WiFi fingerprint collected and received from the mobile terminal 111 and each WiFi fingerprint in the database is calculated, a collecting point of a WiFi fingerprint with the shortest one of the calculated distances may be estimated as the location of the mobile terminal 111.

Information on the determined site may be displayed on the registering person's terminal 110 so that the registering person may check or correct the information.

Once the information on the site where the registered mobile application is to be provided is determined, the mobile application registration unit 211 stores the information on the determined site and the information on the link with the mobile application in the mobile application management search database 220.

### Registration of Mobile Application Based on Site Ontology

In an embodiment of the present invention, a method for specifying a range for providing a mobile application and registering the mobile application based on a site ontology will be described.

The present embodiment is characterized by generating and using the concept of site ontology. The site ontology is a directory system for semantically classifying the entire set of sites. The site ontology database 160 (see FIG. 4) has predefined classification items for a physical site directory and a logical site directory, i.e., symbolic tags which include physical symbolic tags and logical symbolic tags.

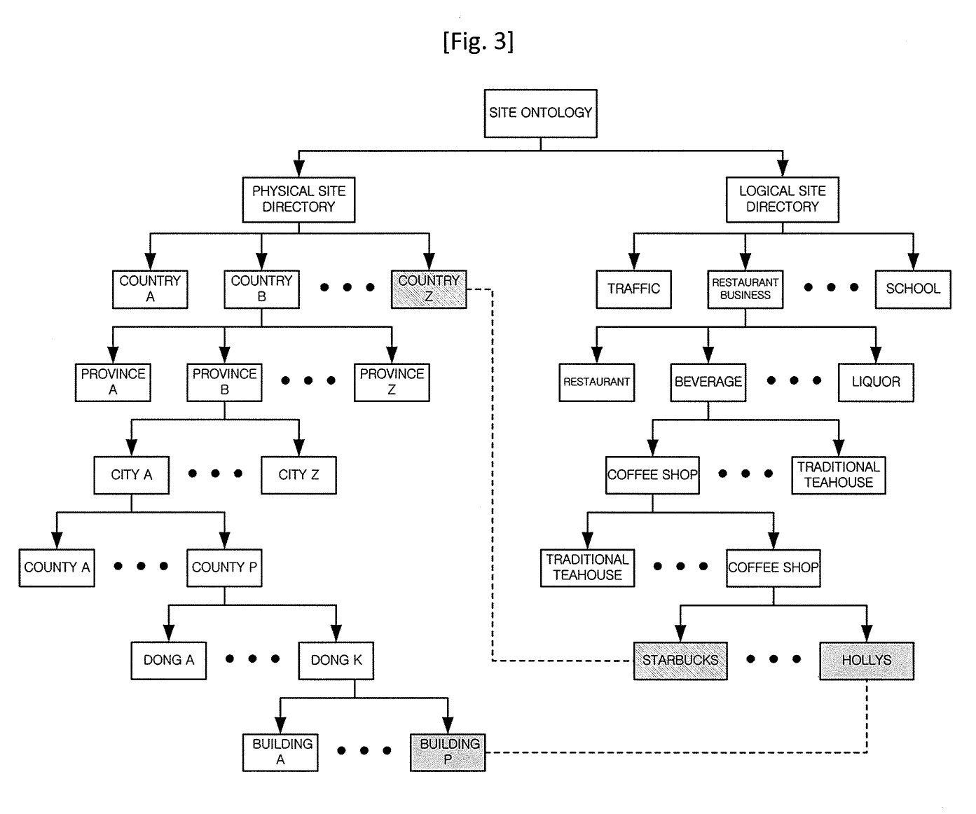

FIG. 3 illustrates a site ontology according to an embodiment of the present invention.

The physical site directory is similar to an address system of country, state, province, city, county, and borough. For a building, a building model for each floor and each room may be grafted into the directory. The logical site directory may be classified into traffic, school, public office, and restaurant business. The school may be further classified into sub-directories of elementary, middle school, high school, and university. The logical site directory may be structured in a variety of forms according to service subjects or implementation schemes and may also be expanded and developed.

If a person registering a mobile application selects a symbolic tag of “Country Z” in the physical site directory and selects a symbolic tag of “STARBUCKS” in the logical site directory, all of sites belonging to “All Starbucks in the Country Z” may be selected as sites where the mobile application is to be provided. For another example, if the registering person selects a symbolic tag of “Building P” in the physical site directory and selects a symbolic tag of “HOLLYS” in the logical site directory, all of sites belonging to “All HOLLYS in the Building P” may be selected as sites where the mobile application is to be provided.

As such, the use of the site ontology to register a mobile application makes it possible to simply and accurately specify sites where the mobile application is to be linked. In particular, it is possible to accurately and simultaneously specify sites which are spaced apart from each other.

On the other hand, each site has its own physical and logical symbolic tags which are already defined before the registering person performs a registration process. Accordingly, if the registering person selects a symbolic tag from each of the physical site directory and the logical site directory, a specific site or a plurality of sites which a mobile application is to be provided may be instantly specified.

The mobile application registration unit 211 receives and registers a mobile application in association with the registering person's terminal 110 and sets a site where the mobile application is to be provided.

The mobile application registration unit 211 provides the registering person with the physical site directory and the logical site directory from the site ontology database 223 so that the registering person may search the physical site directory and the logical site directory in a sequential manner from the top tag down to the lower tags and determine a site where the mobile application is to be provided. As discussed earlier, the symbolic tags may be selected so that one or more sites where a mobile application is to be provided may be selected. Once the registering person completes the selection, information on a geographical area where the mobile application is to be provided may be marked on a map so that the registering person may check the site. The information on the site selected by the registering person is stored in the linked site-mobile application database 222.

### Search and Providing of Mobile Application

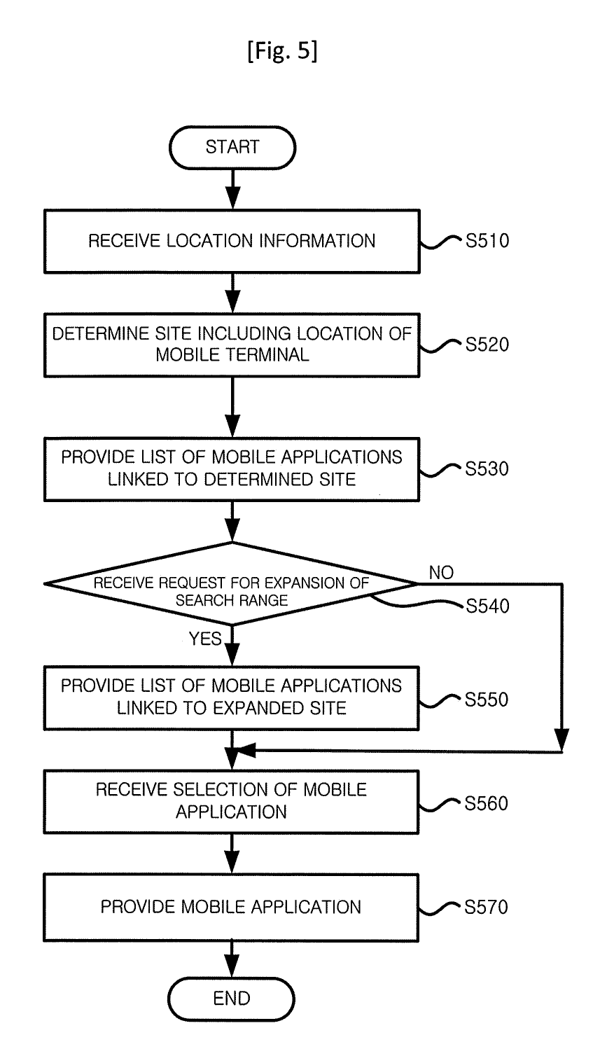

FIG. 5 illustrates a method for searching and providing a mobile application based on location information received from a mobile terminal.

When receiving a request for a list of mobile applications from the user's mobile terminal 300, the mobile application list unit 212 receives location information of the mobile terminal 300 from the mobile terminal 300 with the request or following the request (S510). The location information represents the location of the mobile terminal 300. For example, the location information may be coordinate information which the mobile terminal 300 calculates based on a signal received from a GPS satellite.

The mobile application list unit 212 determines a site including the location of the mobile terminal 300 (S520). Each site has a range of a geographical area which is defined in numerical values and is stored in the mobile application management search database 220. Accordingly, the mobile application list unit 212 may refer to the mobile application management search database 220 to determine a site including the location of the mobile terminal 300.

The mobile application list unit 212 provides the mobile terminal 300 with a list of mobile applications linked to the determined site (S530). The mobile terminal 300 which has received the list of mobile applications may make a request for expansion of search range if a desired mobile application is not present in the list of mobile applications.

Upon receipt of the request for expansion of search range, the mobile application list unit 212 expands the search range beyond the determined site, generates a list of mobile applications linked to sites within the expanded search range, and provides the list of mobile applications for the mobile terminal 300 (S540, S550).

Information on selection of a mobile application selected from among the list of mobile applications is received from the mobile terminal 300 (S560). The mobile application unit 214 provides the selected mobile application based on the received selection information (S570).

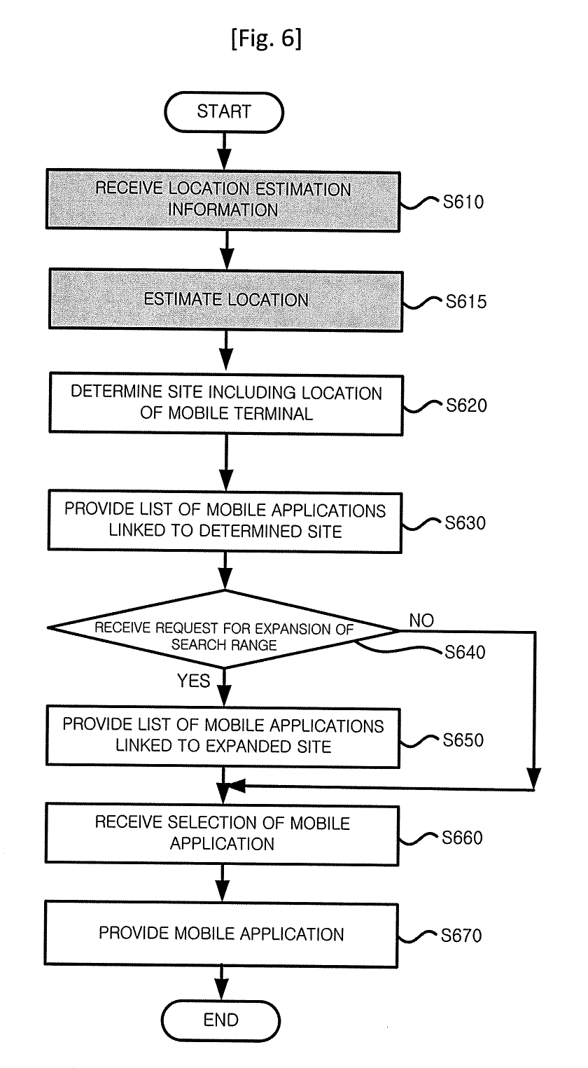

FIG. 6 illustrates a method for searching and providing a mobile application based on location estimation information received from a mobile terminal.

The mobile application list unit 212 receives a request for a list of mobile applications from the user's mobile terminal 300 and receives location estimation information of the mobile terminal 300 from the mobile terminal 300 with the request or after the request (S610).

The location estimation information is used to estimate the location of the mobile terminal 300. For example, the location estimation information may be a WiFi fingerprint generated by the mobile terminal.

The location estimation unit 213 estimates the location of the mobile terminal 300 using the location estimation information (S615). For example, if the WiFi fingerprint is received as the location estimation information, the location estimation unit 213 estimates the location of the mobile terminal 300 using the received WiFi fingerprint and the WiFi radio map 224. The location estimation method may use the method described in the section “Registration of Mobile Application Based on Coordinates”.

The mobile application list unit 212 determines a site including the estimated location (S620). The operations of S620 through S670 are substantially the same as the operations of S520 through S570 in FIG. 5 and a detailed description thereof will thus be omitted.

### Faster Search of Mobile Application

An increased number of registered mobile applications linked to a site causes increased time taken to search for available mobile applications at a certain location. For example, in order to check without any preparation which of M areas certain coordinates fall within, all of the M areas should be checked. In addition to an increased number of registered mobile applications, an exponentially increased number of sites cause a huge amount of computing power and time consumption for such a checking.

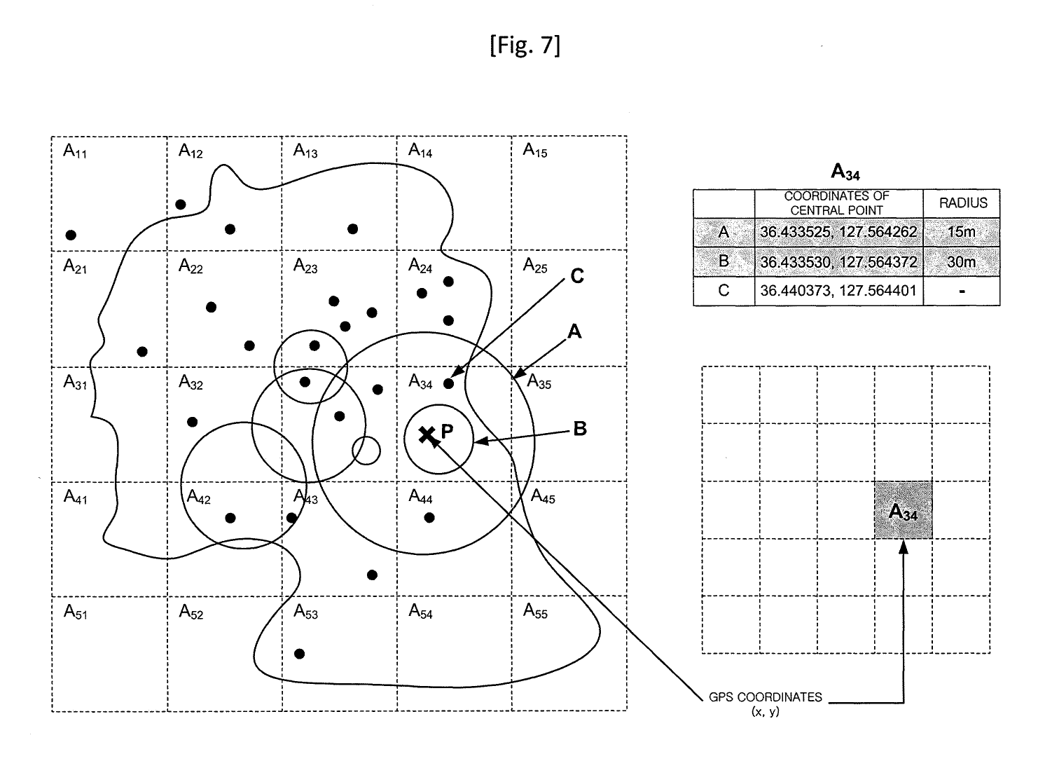

FIG. 7 illustrates a search method using a space index array according to an embodiment of the present invention.

The entire area where the mobile application is to be provided is divided into grid areas of a predetermined size. FIG. 7 illustrates a total of twenty-five grids of A₁₁ to A₅₅. The coordinate range of each of the grid areas is stored in the space index array database 225. If more than one site is overlapped with a certain grid area, a list of the sites corresponding to the grid area is stored in the space index array database 225.

For example, in FIG. 7, when sites A, B and C are overlapped with the grid area A₃₄, a mapping relation between information on the grid area A₃₄ and information on the sites A, B and C is stored in the space index array database 225. The site information may be implemented in a variety of forms. For example, the site information may be defined in the form of coordinates of the central point of the site and the radius of the site, or in the form of a set of apexes of a polygon. FIG. 7 illustrates the information of the sites A to C using the coordinates of the central point of the site and the radius of the site.

Assuming that the coordinate range for each of grid areas is determined, when location information of the mobile terminal 300 at the point ‘P’ is received, the location information is used to determine a grid area with a coordinate range which the coordinates of the point ‘P’ fall within.

If it is recognized from the coordinates of the point ‘P’ that the mobile terminal 300 is located within the grid area A₃₄, a list of sites set within the grid area is checked. If it is recognized that the sites A, B and C are overlapped within the grid area A₃₄, it is determined whether the mobile terminal 300 at the point ‘P’ falls within the sites A to C using the range information of the sites A to C. In this case, a distance between the coordinates of the point ‘P’ and the coordinates of the central point of each of the sites is calculated. If the calculated distance is smaller than the radius, it may be determined that the mobile terminal 300 at the point ‘P’ falls within a site corresponding to the radius.

In the case of not using the space index array, when the location information of the mobile terminal 300 is received, a distance between the position of the central point of each of registered sites and the received location information is calculated and compared with the radius of each of the sites to check whether or not to overlap with a search area. In this case, since a distance between the central point of each of registered sites and the received location information has to be calculated, a great deal of system resources and time are consumed in the process of selecting sites including the location of the mobile terminal 300.

In the case of using the space index array according to the present embodiment, however, since it is possible to reduce the number of sites to check whether or not to overlap, it is possible to reduce resource consumption and quickly generate a list of sites where the mobile application 300 is located.

### 3. Registration and Search of Mobile Application Without Location Estimation

### Mobile Application Marketplace System

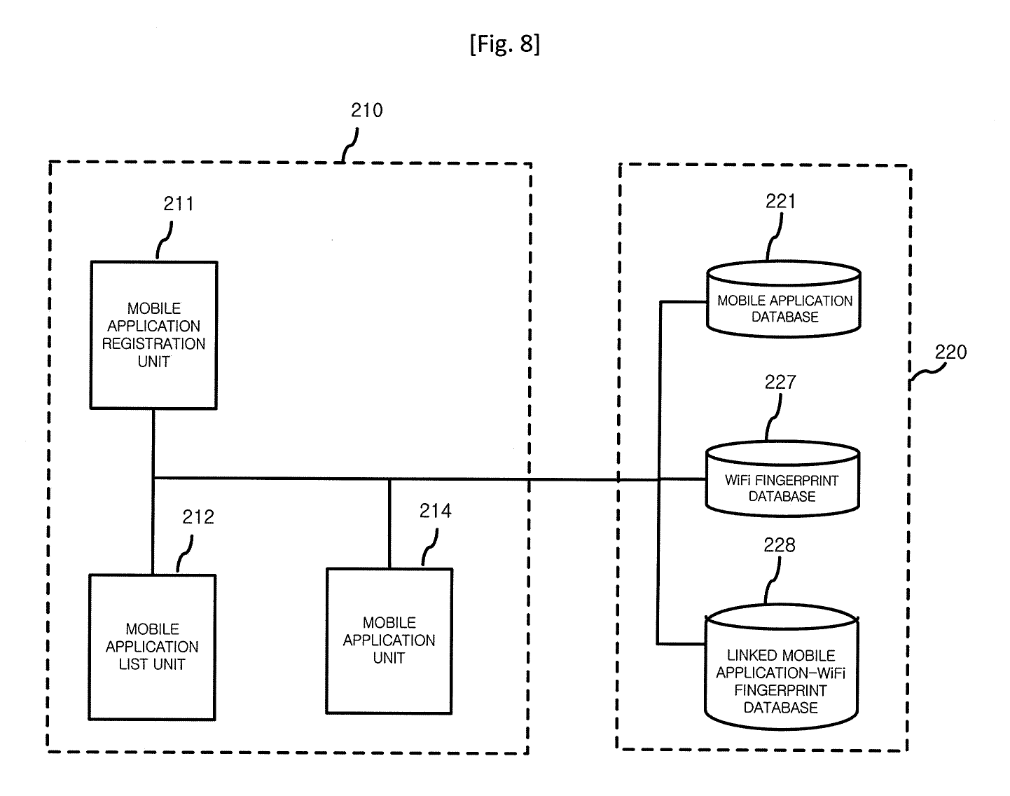

FIG. 8 illustrates a structure of a mobile application marketplace system without location estimation according to an embodiment of the present invention.

The mobile application management search server 210 includes a mobile application registration unit 211, a mobile application list unit 212, and a mobile application unit 214.

The mobile application registration unit 211 receives (i) a mobile application which is to be provided for a mobile terminal at a particular location, and (ii) a WiFi fingerprint collected at the particular location, which is a set of identification information of an AP outputting a WiFi signal and a WiFi signal strength.

The mobile application registration unit 211 stores information on a link between the mobile application and the WiFi fingerprint in the mobile application management search database 220.

The mobile application list unit 212 receives a WiFi fingerprint from the mobile terminal which wishes to receive the mobile application. The mobile application list unit 212 compares the received WiFi fingerprint with each of WiFi fingerprints stored in the mobile application management search database 220 to extract a WiFi fingerprint with a similarity of a predetermined level or more from among the WiFi fingerprints already stored in the mobile application management search database 220, generates a list of mobile applications which are linked to the extracted WiFi fingerprint, and provides the list of mobile applications for the mobile terminal.

The mobile application management search database 220 includes a mobile application database 221, a WiFi fingerprint database 227 and a linked mobile application-WiFi fingerprint database 228.

The mobile application database 221 stores mobile applications which are to be provided at particular locations. The WiFi fingerprint database 227 stores WiFi fingerprints collected at particular locations where mobile applications are to be provided.

The linked mobile application-WiFi fingerprint database 228 stores information on a link between the provided mobile application and the WiFi fingerprint.

Functions of the mobile application marketplace system 200 will be more apparent from the following description of the registration and search of mobile applications.

### Registration of Mobile Application

The mobile application marketplace system 200 receives (i) a mobile application which is to be provided for a mobile terminal at a particular location, and (ii) a WiFi fingerprint collected at the particular location, which is a set of identification information of an AP outputting a WiFi signal and a WiFi signal strength, and builds a database on a link between the provided mobile application and the WiFi fingerprint.

Specifically, the mobile application registration unit 211 of the mobile application marketplace system 200 receives a mobile application to be provided at a particular location in association with the registering person's terminal 110 and stores the mobile application in the mobile application database 221.

The mobile application registration unit 211 also receives a WiFi fingerprint collected at the particular location where the mobile application is to be provided, and stores the WiFi fingerprint in the WiFi fingerprint database 227. The collection of the WiFi fingerprint may be performed by the registering person's mobile terminal 111. In the event that the collection is performed by the registering person, the mobile terminal 111 collects the WiFi fingerprint while the registering person puts the mobile terminal 111 at a location where the mobile application is to be provided. The WiFi fingerprint is a set of identification information of the AP 130, which outputs the WiFi signal that can be collected at the location where the mobile terminal 111 is located, and the WiFi signal strength.

A single WiFi fingerprint may be collected in a place where the mobile application is to be provided. Alternatively, a plurality of WiFi fingerprints may be collected at a plurality of locations within a place where the mobile application is to be provided. This is because WiFi fingerprints collected in a wide place may have significantly different values although the WiFi fingerprints are collected in the same place.

Upon receipt of the WiFi fingerprints, the mobile application registration unit 211 assigns an identifier to each of the WiFi fingerprints, stores the identifier in the WiFi fingerprint database 227, and stores information on a link between the mobile application and the WiFi fingerprint in the linked mobile application-WiFi fingerprint database 228.

### Search and Providing of Mobile Application

The mobile application marketplace system 200 receives a WiFi fingerprint from a mobile terminal which wishes to receive a mobile application.

The mobile application marketplace system 200 compares the received WiFi fingerprint with each of WiFi fingerprints stored in the database to extract a WiFi fingerprint with a similarity of a predetermined level or more from among the WiFi fingerprints already stored in the database, and provides the mobile terminal with a list of mobile applications which are linked to the extracted WiFi fingerprint.

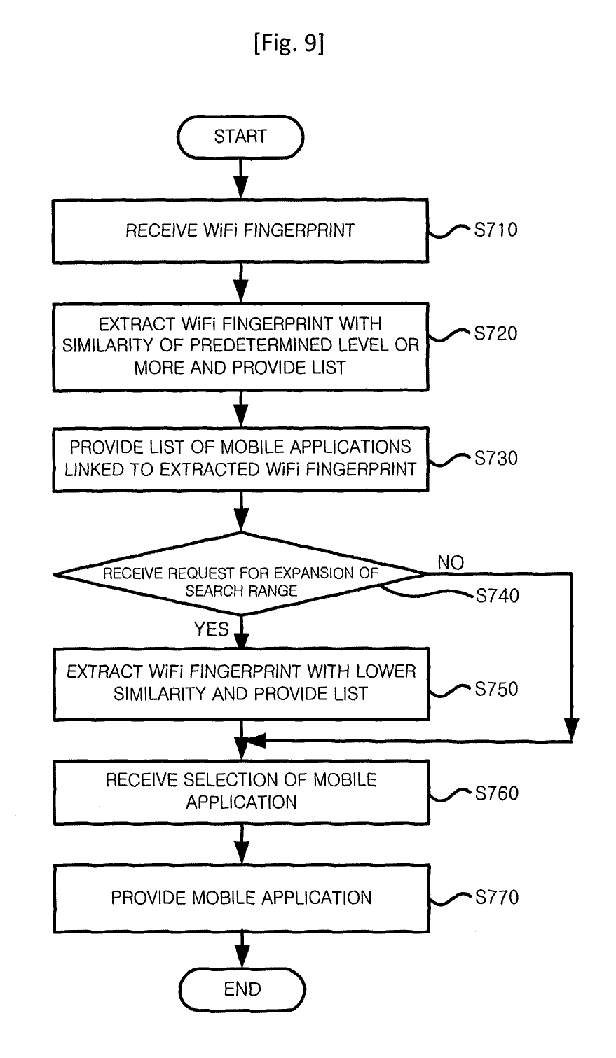

FIG. 9 illustrates a method for searching and providing a mobile application by a mobile application marketplace system according to an embodiment of the present invention.

The mobile application list unit 212 of the mobile application management search server 210 receives a WiFi fingerprint from the mobile terminal 300 (S710). A user who requests for a list of mobile applications puts the user's mobile terminal 300 at a location where a mobile application is to be provided, measures and collects a WiFi fingerprint at the location, and provides the WiFi fingerprint for the mobile application management search server 210.

The mobile application list unit 212 compares the received WiFi fingerprint with each of WiFi fingerprints stored in the WiFi fingerprint database 227 to extract a WiFi fingerprint with a similarity of a predetermined level or more from among the WiFi fingerprints already stored in the WiFi fingerprint database 227 (S720). The similarity may be measured by, for example, the method using the Euclidian distance, which has been discussed in the section ‘Registration of Mobile Application Based on Coordinates’. In this case, the shorter Euclidian distance, the greater similarity will be obtained.

It should be understood that if there is no WiFi fingerprint extracted in the above process, the similarity level may be lowered.

By referring to the linked mobile application-WiFi fingerprint database 228, a list of mobile applications linked to the extracted WiFi fingerprint is extracted and provided for the mobile terminal (S730).

The mobile terminal 300 checks the list of mobile applications. If a desired mobile application is not present in the list of mobile applications, the mobile terminal 300 may make a request for expansion of the range of the list of mobile applications.

If the mobile application management search server 200 receives the request for expansion of the range of the list, the mobile application management search server 200 extracts a WiFi fingerprint with a lower similarity level and provides a list of mobile applications linked to the extracted WiFi fingerprint (S740, S750).

If the user selects a desired mobile application from among the list of mobile applications, the mobile application management search server 210 receives a selection signal of the desired mobile application from the mobile terminal 300 (S760), outputs the desired mobile application from the mobile application database 221, and provides the desired mobile application for the mobile terminal 300 (S770).

According to the exemplary embodiments of the present invention, a geographical range of a location where a mobile application is to be provided may not be specified in exact numerical values, and a location of a mobile terminal 300 which wishes to receive a mobile application may not be determined or estimated. Accordingly, a service provider providing the service according to the embodiments of the present invention may not prepare a geographical map or a WiFi radio map for implementing the present embodiments.

The embodiments of the present invention cannot be implemented only through the apparatus and the method, but also be implemented as programs or through a computer readable recording medium on which the programs are recorded. Such implementation may be easily achieved by those skilled in the art from the above description of the embodiments.

Although the present invention has been described with reference to some embodiments in conjunction with the drawings, it should be understood that these embodiments are given by way of illustration only and do not limit the scope of the invention, and that various modifications, variations, and alterations can be made by those skilled in the art without departing from the spirit and scope of the following claims.

For example, in the embodiment of the present invention, the elements constituting the mobile application management search server are present within a single server. However, the elements constituting the mobile application management search server may be distributed among a plurality of servers or operated by different service providers. In addition, the databases constituting the mobile application management search database may be distributed among a plurality of locations or owned by different service providers.

Although the embodiments of the present invention have been separately described according to the specified methods, it should be understood that the present invention may be implemented with a combination of the embodiments.

1. A marketplace system providing a mobile application for a mobile terminal, the marketplace system comprising:
a mobile application registration unit configured to allow a user to register a mobile application which is to be provided for a mobile terminal;
a linked site-mobile application database configured to store information on a link between a mobile application and a site which a mobile application is to be provided for; and
a mobile application list unit configured to receive location information from a mobile terminal which wishes to receive a mobile application, determine a site including a location of the mobile terminal, which wishes to receive the mobile application, based on the received location information, generate a list of mobile applications linked to the determined site using the linked site-mobile application database, and provide the list of mobile applications for the mobile terminal which wishes to receive the mobile application.

2. A marketplace system providing a mobile application for a mobile terminal, the marketplace system comprising:
a mobile application registration unit configured to allow a user to register a mobile application which is to be provided for a mobile terminal;
a linked site-mobile application database configured to store information on a link between a mobile application and a site which a mobile application is to be provided for; and
a mobile application list unit configured to receive a WiFi fingerprint as location estimation information used to estimate a location of a mobile terminal from the mobile terminal which wishes to receive a mobile application, determine a site including an estimated location from the received WiFi fingerprint, generate a list of mobile applications linked to the determined site using the linked site-mobile application database, and provide the list of mobile applications for the mobile terminal which wishes to receive the mobile application, wherein the WiFi fingerprint is a set of identification information of an access point (AP), which outputs a WiFi signal received by the mobile terminal which wishes to receive the mobile application, and a WiFi signal strength.

3. The marketplace system of claim 1, further comprising a site ontology database which includes a physical site directory and a logical site directory and includes predefined symbolic tags which are classification items of each of the physical site directory and the logical site directory.

4. The marketplace system of claim 1, further comprising a space index array database (225) configured to store information on a coordinate range of each of grid areas which are formed by dividing an entire space which mobile applications are to be provided for, and information on sites which overlap with each of the grid areas.

5. The marketplace system of claim 4, wherein the determination of a site including a location of the mobile terminal which wishes to receive the mobile application is performed using the space index array database (225).

6. A method for providing a mobile application for a mobile terminal, the method comprising:
storing a mobile application which is to be provided for a mobile terminal;
storing site-mobile application link information which is information on a link between the stored mobile application and a site which the stored mobile application is to be provided for;
receiving information on a location of a mobile terminal from the mobile terminal which wishes to receive a mobile application;
determining a site including the location of the mobile terminal, which wishes to receive the mobile application, based on the received location information; and
generating a list of mobile applications linked to the determined site using the site-mobile application link information and providing the list of mobile applications for the mobile terminal which wishes to receive the mobile application.

7. A method for providing a mobile application for a mobile terminal, the method comprising:
storing a mobile application which is to be provided for a mobile terminal;
storing site-mobile application link information which is information on a link between the stored mobile application and a site which the stored mobile application is to be provided for;
receiving a WiFi fingerprint as location estimation information used to estimate a location of a mobile terminal from the mobile terminal which wishes to receive a mobile application, the WiFi fingerprint being a set of identification information of an access point (AP), which outputs a WiFi signal received by the mobile terminal, and a WiFi signal strength;
estimating a location of the mobile terminal, which wishes to receive the mobile application, from the received WiFi fingerprint and determining a site including the estimated location; and
generating a list of mobile applications linked to the determined site using the site-mobile application link information and providing the list of mobile applications for the mobile terminal which wishes to receive the mobile application.

8. The method of claim 6, wherein in generating the site-mobile application link information, a site which a mobile application is to be provided for is selected by selecting a specific symbolic tag in a site ontology database which includes a physical site directory and a logical site directory and includes predefined symbolic tags which are classification items of each of the physical site directory and the logical site directory.

9. The method of claim 6, wherein the determining of a site including the location of the mobile terminal which wishes to receive the mobile application is performed using a space index array database (225) which is configured to store information on a coordinate range of each of grid areas which are formed by dividing a space, and information on sites which overlap with each of the grid areas.

10. A marketplace system providing a mobile application for a mobile terminal, the marketplace system comprising:
a mobile application registration unit (211) configured to receive (i) a mobile application which is to be provided for a mobile terminal at a particular location and (ii) a WiFi fingerprint collected at the particular location, the WiFi fingerprint being a set of identification information of an access point (AP) outputting a WiFi signal and a WiFi signal strength, and store information on a link between the received mobile application and the WiFi fingerprint in a mobile application management search database (220); and
a mobile application list unit (212) configured to receive a WiFi fingerprint from a mobile terminal which wishes to receive a mobile application, compare the received WiFi fingerprint with each of WiFi fingerprints stored in the mobile application management search database (220) to extract a WiFi fingerprint with a similarity of a predetermined level or more from among the WiFi fingerprints stored in the mobile application management search database (220), generate a list of mobile applications which are linked to the extracted WiFi fingerprint, and provide the list of mobile applications for the mobile terminal which wishes to receive the mobile application

11. The marketplace system of claim 10, wherein the similarity is determined by a Euclidean distance between each of the WiFi fingerprints, which are stored in the mobile application management search database (220), and the WiFi fingerprint, which is received from the mobile terminal which wishes to receive the mobile application.

12. A method for providing a mobile application for a mobile terminal, the method comprising:
receiving (i) a mobile application which is to be provided for a mobile terminal at a particular location and (ii) a WiFi fingerprint collected at the particular location, the WiFi fingerprint being a set of identification information of an access point (AP) outputting a WiFi signal and a WiFi signal strength;
building a database storing information on a link between the received mobile application and the WiFi fingerprint;
receiving a WiFi fingerprint from a mobile terminal which wishes to receive a mobile application;
comparing the WiFi fingerprint, which is received from the mobile terminal which wishes to receive the mobile application, with each of WiFi fingerprints stored in the database to extract a WiFi fingerprint with a similarity of a predetermined level or more from among the WiFi fingerprints stored in the database, and providing a list of mobile applications, which are linked to the extracted WiFi fingerprint, for the mobile terminal which wishes to receive the mobile application.

13. The method of claim 12, wherein the similarity is determined by a Euclidean distance between each of the WiFi fingerprints, which are stored in the database, and the WiFi fingerprint, which is received from the mobile terminal which wishes to receive the mobile application.
